(19) United States
(12) Patent Application Publication
(10) Pub. No.: US 2018/0012255 A1
(43) Pub. Date: Jan. 11, 2018

(54) Comprehensive business marketing methodology integrating business, community, community organizations and consumer, and simultanously integrating and adapting technologies: internet, mobile device, location navigation, application and QR code technology

(71) Applicant: Sherry Ann Tulk, Charleston, WV (US)

(72) Inventor: Sherry Ann Tulk, Charleston, WV (US)

(21) Appl. No.: 14/999,819

(22) Filed: Jul. 5, 2016

(51) Int. Cl. G06Q 30/02; G06K 7/14

(52) U.S. Cl. CPC G06Q 30/0257; G06K 7/1417; G06Q 30/0267

(57) ABSTRACT

This invention is an Internet based marketing methodology connecting businesses, communities, and good/service seekers. Small-to-medium-sized business information is posted on a Web page and/or physical outdoor sign board structure, with the website made available as a link on community based websites. The process then utilizes existing technology to create a mobile device downloadable application of the website from the Internet, or from a QR scanning code from the outdoor sign board. The intent is a comprehensive marketing plan utilizing and adapting existing technology and relationship development to create name recognition, and easily accessible local business information for customer/users.

### PRIOR PUBLICATION DATA

Provisional application No. 62/195,003, filed on Jul. 21, 2015.

### REFERENCES TO RELATED APPLICATIONS

### U.S. Patent Documents

U.S. Pat. No. 5,319,542 A June 1994 King, Jr. et al.
U.S. Pat. No. 5,515,270 A May 1996 Weinblatt
U.S. Pat. No. 5,537,314 A July 1996 Kanter
U.S. Pat. No. 5,590,197 A December 1996 Chen et al.
U.S. Pat. No. 5,600,778 A February 1997 Swanson et al.
U.S. Pat. No. 5,630,125 A May 1997 Zellweger
U.S. Pat. No. 5,699,528 A December 1997 Hogan
U.S. Pat. No. 5,710,887 A January 1998 Chelliah et al.
U.S. Pat. No. 5,712,979 A January 1998 Graber et al.
U.S. Pat. No. 5,715,314 A February 1998 Payne et al.
U.S. Pat. No. 5,717,860 A February 1998 Graber et al.
U.S. Pat. No. 5,721,827 A February 1998 Logan et al.
U.S. Pat. No. 5,724,424 A March 1998 Gifford
U.S. Pat. No. 5,7724,521 A March 1998 Derrick
U.S. Pat. No. 5,727,159 A March 1998 Kikinis
U.S. Pat. No. 5,737,538 A April 1998 Wilhite
U.S. Pat. No. 5,745,681 A April 1998 Levine et al.
U.S. Pat. No. 5,768,528 A June 1998 Stumm
U.S. Pat. No. 5,778,367 A July 1998 Wesinger, Jr. et al.
U.S. Pat. No. 5,793,368 A August 1998 Beer
U.S. Pat. No. 5,796,393 A August 1998 MacNaughton et al.
U.S. Pat. No. 5,796,952 A August 1998 Davis et al.
U.S. Pat. No. 5,798,733 A August 1998 Ethridge
U.S. Pat. No. 5,802,299 A September 1998 Logan et al.
U.S. Pat. No. 5,809,481 September 1998 Baron et al.
U.S. Pat. No. 5,812,769 A September 1998 Craber et al.
U.S. Pat. No. 5,818,446 A October 1998 Bertram et al.
U.S. Pat. No. 5,819,285 A October 1998 Damico et al.
U.S. Pat. No. 5,825,884 A October 1998 Zdepski et al.
U.S. Pat. No. 5,848,396 A December 1998 Grace
U.S. Pat. No. 5,850,442 A December 1998 Muftic
U.S. Pat. No. 5,860,068 A January 1999 Cook
U.S. Pat. No. 5,862,325 A January 1999 Reed et al.
U.S. Pat. No. 5,870,717 A February 1999 Witch a
U.S. Pat. No. 5,878,219 A March 1999 Vance, Jr. et al.
U.S. Pat. No. 5,884,033 A March 1999 Duvall et al.
U.S. Pat. No. 5,884,045 A March 1999 Kurihara
U.S. Pat. No. 5,890,171 A March 1999 Blumer et al.
U.S. Pat. No. 5,890,175 A March 1999 Wong et al.
U.S. Pat. No. 5,893,091 A April 1999 Hunt et al.
U.S. Pat. No. 5,894,554 A April 1999 Lowery et al.
U.S. Pat. No. 5,895,468 A April 1999 Whitmyer Jr.
U.S. Pat. No. 5,897,622 A April 1999 Blinn et al.
U.S. Pat. No. 5,898,836 A April 1999 Freivald et al.
U.S. Pat. No. 5,907,830 A May 1999 Engel et al.
U.S. Pat. No. 5,913,040 A June 1999 Rakavy et al.
U.S. Pat. No. 5,913,202 A June 1999 Motoyama
U.S. Pat. No. 5,915,243 A June 1999 Smolen
U.S. Pat. No. 5,918,010 A June 1999 Appleman et al.
U.S. Pat. No. 5,918,239 A June 1999 Allen et al.
U.S. Pat. No. 5,926,798 A July 1999 Carter
U.S. Pat. No. 5,930,765 A July 1999 Martin
U.S. Pat. No. 5,930,777 A July 1999 Barber
U.S. Pat. No. 5,933,811 A August 1999 Angles et al.
U.S. Pat. No. 5,937,392 A August 1999 Alberts
U.S. Pat. No. 5,940,834 A August 1999 Pinard et al.
U.S. Pat. No. 5,940,843 A August 1999 Zucknovich et al.
U.S. Pat. No. 5,948,061 A September 1999 Merriman et al.
U.S. Pat. No. 5,956,709 A September 1999 Due
U.S. Pat. No. 5,963,915 A October 1999 Kirsch
U.S. Pat. No. 5,970,472 A October 1999 Allsop et al.
U.S. Pat. No. 5,978,766 A November 1999 Luciw
U.S. Pat. No. 5,983,227 A November 1999 Nazem et al.
U.S. Pat. No. 5,983,270 A November 1999 Abraham et al.
U.S. Pat. No. 5,987,498 A November 1999 Athing et al.
U.S. Pat. No. 5,991,735 A November 1999 Gerace
U.S. Pat. No. 5,991,740 A November 1999 Messer
U.S. Pat. No. 6,012,098 A January 2000 Bayeh et al.
U.S. Pat. No. 6,014,638 A January 2000 Burge et al.
U.S. Pat. No. 6,016,494 A January 2000 Isensee et al.
U.S. Pat. No. 6,016,504 A January 2000 Arnold et al.
U.S. Pat. No. 6,023,714 A February 2000 Hill et al.
U.S. Pat. No. 6,029,141 A February 2000 Bezos et al.
U.S. Pat. No. 6,032,130 A February 2000 Alloul et al.
U.S. Pat. No. 6,035,281 A March 2000 Crosskey et al.
U.S. Pat. No. 6,073,124 A June 2000 Krishnan et al.
U.S. Pat. No. 6,128,655A October 2000 Fields et al.
U.S. Pat. No. 6,111,006 A October 2000 Knowlton et al.
U.S. Pat. No. 6,141,666 A October 2000 Tobin
U.S. Pat. No. 6,151,601 A November 2000 Papierniak et al.
U.S. Pat. No. 6,209,007 B1 March 2001 Kelley et al.
U.S. Pat. No. 6,230,173 B1 May 2001 Ferrel et al.
U.S. Pat. No. 6,247,047 B1 June 2001 Wolff
U.S. Pat. No. 6,249,773 B1 June 2001 Allard et al
U.S. Pat. No. 6,253,188 B1 June 2001 Witek et al.
U.S. Pat. No. 6,330,575 B1 December 2001 Moore et al.
U.S. Pat. No. 6,345,239 B1 Feb. 2002 Bowman-Amuah
U.S. Pat. No. 6,356,903 B1 March 2002 Baxter
U.S. Pat. No. 6,490,567 B1 December 2002 Gregory
U.S. Pat. No. 6,564,320 B1 May 2003 de Silva et al.
U.S. Pat. No. 6,572,662 B2 June 2003 Manohar et al.
U.S. Pat. No. 6,615,259 B1 September 2003 Nguyen et al.
U.S. Pat. No. 6,629,135 B1 September 2003 Ross et al.
U.S. Pat. No. 6,684,239 B1 January 2004 Flepp
U.S. Pat. No. 6,742,028 B1 May 2004 Wang
U.S. Pat. No. 6,763,343 B1 July 2004 Brooke
U.S. Pat. No. 6,886,013 B1 April 2005 Beranek
U.S. Pat. No. 6,889,222 B1 May 2005 Zhao
U.S. Pat. No. 7,028,034 B2 April 2006 Wesinger, Jr.
U.S. Pat. No. 7,031,875 B2 April 2006 Ellenby et al.
U.S. Pat. No. 7,032,030 B1 April 2006 Codignotto
U.S. Pat. No. 7,039,594 B1 May 2006 Gersting
U.S. Pat. No. 7,058,597 B1 June 2006 Ronning et al.
U.S. Pat. No. 7,181,468 B2 Feb. 2007 Spring et al.
U.S. Pat. No. 7,269,591 B2 September 2007 Wesinger, Jr.
U.S. Pat. No. 7,301,450 B2 November 2007 Carrino
U.S. Pat. No. 7,337,133 B1 Feb. 2008 Bezos et al.
U.S. Pat. No. 7,401,138 B2 July 2008 Bison
U.S. Pat. No. 7,409,634 B2 August 2008 Davis
U.S. Pat. No. 7,415,484 B1 August 2008 Tulkoff
U.S. Pat. No. 7,426,687 B1 September 2008 Schultz
U.S. Pat. No. 7,447,793 B2 November 2008 Morioka
U.S. Pat. No. 7,472,427 B2 December 2008 Shimojima
U.S. Pat. No. 7,493,287 B1 Feb. 2009 Sequeira
U.S. Pat. No. 7,505,913 B2 March 2009 Tobin
U.S. Pat. No. 7,512,607 B2 March 2009 Nagano
U.S. Pat. No. 7,565,308 B1 July 2009 Bollay
U.S. Pat. No. 7,920,849 B2 April 2011 Pop
U.S. Pat. No. 7,930,207 B2 April 2011 Merriman et al.
U.S. Pat. No. 8,046,255 B2 October 2011 Bistriceanu et al.
U.S. Pat. No. 8,447,642B2 May 2013 Zaccagnino et al.
U.S. Pat. No. 8,866,673 B2 October 2014 Mendelson
U.S. Pat. No. 9,043,228 B1 May 2015 Ross, Jr. etc al.
2002/0065772 A1 May 2002 Saliba et al.
2002/0095333 A1 July 2002 Jokinen et al.
2002/0194337 A1 December 2002 Knight et al.
2003/0003912 A1 January 2003 Melpignano et al.
2003/0006911 A1 January 2003 Smith et al.
2004/0042432 A1 March 2004 Riazi et al.
2004/0059708 A1 March 2004 Dean et al.
2004/0077340 A1 April 2004 Forsyth
2004/0117442 A1 June 2004 Thielen
2004/0165007 A1 August 2004 Shafron
2005/0071328 A1 March 2005 Lawrence
2005/0222989 A1 October 2005 Haveliwala et al.
2005/0240580 A1 October 2005 Zamir et al.
2006/0059044 A1 March 2006 Chan et al.
2006/0122767 A1 June 2006 Athalye
2006/0253226 A1 November 2006 Mendelson
2007/0073589 A1 March 2007 Vergeyle et al.
2007/0295803 A1 December 2007 Levine et al.
2008/0201488 A1 August 2008 Kenner et al.
2008/0227473 A1 September 2008 Haney
2009/0030774 A1 January 2009 Rothschild et al.

### FEDERALLY SPONSORED RESEARCH OR DEVELOPMENT

Not Applicable

### REFERENCE TO SEQUENCE LISTING

Not Applicable

### BACKGROUND OF INVENTION

### 1. Field of Invention

This invention pertains to Web based, mobile device downloadable application and QR scanning code of local content and categorical local marketing. The methodology integrates these technologies while also integrating business marketing and community, creating a technology-relational process, connecting businesses, communities, community and customers.

### 2. Description of Prior Art

Early online marketing and advertising, as to be expected, started from the business/seller perspective. Banner ads, being some of the first, were initially a no cost solution to increase name recognition beyond company websites and commerce listings. These ads evolved into pay per click or purchase and to development of web hosting sites for business advertising. A host site provides business and product information creating the feel of the business website, utilizing product object representatives or a predetermined representation with, and/or as website link. Banner ads and website hosting marketing serve to increase name recognition and increase access to product and service information of participating businesses but the focus is marketing to the consumer, not relationship development, and is only accessible to those who visit the host website or come across the banner ad.

Another business perspective marketing invention increases search engine optimization. The intent is for business website or commerce listings to appear in top ten search results. Business owners purchase “key words” relevant to their business. The objective is for the company to select “key words” based on those used in the business name, description, and/or website excerpts which are also common search words. While search engines advance marketing opportunity with “key word” creation, this does not diminish the expansive global resulting list to desired local content, nor of the partial irrelevant content. While this problem was solved in part using GPS tracking and location technology, search engine results remain extensive and do not always provide what searchers are looking for.

Two more recent technology based inventions approach marketing from a dual perspective, both business owner and consumer, or good/service seeker, with a local content focus. The first invention is to provide user/potential consumer control of content and WiFi based mobile device options. Users opt-in for local content to receive business marketing information based on user selected optional categories, subcategories and device reception options via email, texting, etc., which is then further adapted to demographic profiling. From the business perspective, information is made available to the user for opt-in, and which includes incentives, promotions and business marketing determined decisions.

Likewise, the second dual business and good/service seekers marketing invention focuses on local content, but is specific to providing local content via blue tooth technology. This invention is also based on consumer opt-in, but delivered specifically utilizing blue tooth technology to allow for indoor and outdoor use. Information received is user defined and is also based on profiling including socio-economic status. The intention of socio-economic status is to target specific levels matched to higher-end products. Another primary aspect is to provide consumers with store and product promotions and incentives through provision of previously non-existent service of indoor mall navigation, creating location based marketing which also has outdoor potential use. Technology has opened up creative marketing opportunities. As described, many inventions offer products which take advantage of these opportunities. Despite this, existing marketing options and services are not comprehensive or all inclusive. This lack of integration and comprehensive planning diminishes marketing success and creates unrealized opportunity for businesses who utilize e-commerce opportunities as well as those who do not. The majority of unrealized opportunity is suffered by small-to-medium-sized business owners. Traditional marketing methodologies primarily target larger companies and corporations, which, for the most part, has not changed with the advent of e-commerce. Also, online search results continue to require much sifting, particularly for local content. Additionally, local content are not typically well known as corporate names and therefore the product or service is unknown to potential customers. An additional missing link or disconnect within the business marketing arena which is more negatively impactful to small-to-medium size business owners, is lack of a comprehensive, integrated, targeted marketing methodology. Comprehensive, integrated, marketing plans encompass perspectives of each entity involved or impacted, and utilizes the most efficient means possible. Thus, this lack of a comprehensive, integrated market plan methodology further hinders small business marketing endeavors.

### SUMMARY

The majority of small-to-medium-sized business owners do not possess the resources to market their companies on an owner desired growth expansion scale. This creates a limiting capacity and in part leads to a number of business failings in the first three to five years of business life. A primary limiter is lack of knowledge of the business good/services and name recognition to allow the business owner to grow to desirable size and revenue level. While potential for good/service seekers to search and find businesses is more accessible than ever before via the Internet, searches often provide seemingly boundless information on a global scale. More recent inventions utilizing GPS and location identification do allow for narrower searches. Despite this searches still remain broad, impersonal, and do not typically provide details of good/service offered, particularly of smaller local businesses. There exists then two missing links for customer and businesses owners in this regard. The first is a lack of easily accessible detailed knowledge of potential good/service options on a local or geographic specific scale. The second relates to online presence if any, in that small businesses owners do not have a website, and may or may not be listed in Web directories. Therefore there is often no information available online to draw potential customers, despite the extensive consumer use of the Internet in pursuit of goods and services.

This invention serves businesses to put good/service information, location and any other information deemed relevant by owners in a category and geographic location specific format in a post-board style website. This is made accessible via links on relevant government and community organizational websites and an optional downloadable application and QR scanning code to mobile devices. The links increase Web traffic for businesses listed and thus name and business information, while the downloadable application and QR code provides information at customer fingertips. Additionally, the mapped location of the business with address and direction search option utilizes GPS technology. The overall concept is a three phased approach which creates business name recognition, and marketing information, with ease of access to potential customers, while integrating businesses and community through online links, applications and business-to-business participation potential.

### DRAWING DESCRIPTIONS

Not Applicable

### DETAILED DESCRIPTION OF INVENTION

Technology evolution provides opportunity for continuing innovating and changing advertising and marketing for companies of all size. For small and medium-sized business owners online marketing opportunity has the ability to level the global playing field. Small and medium size businesses are an underserved e-commerce market. My invention is a phased, comprehensive, integrating process of relationship building and information provision to not only increase name recognition and information and description of goods/services offered by the small business owner, but also creates ease and more ready accessibility of customer initiated information, utilizing and adapting existing technology.

Many small business owners do not possess the resources to market their businesses. Often business owners rely on word-of-mouth and owner self promotion as the only or primary marketing tools, have no marketing plan and typically no company website or online presence, or limited to a yellow page listing. This lack of marketing reduces business strength, owner desired growth and plays a part in business failings. Additionally, online marketing options lack ability to provide strong tools in way of local content for small business marketing budgets. Despite the advent of Internet marketing opportunities, disconnects continue to exist. Web search results pull together hundreds, thousands, sometimes millions of options. This creates further challenge for small-business owners that do have an online presence. The two primary problems for small to-medium size businesses then, are no formal or a minimal marketing plan, and/or no or limited online presence. This invention is intended to resolve these two problems for small business owners.

My invention was developed to aide small-to-medium-sized business owners develop a marketing plan. The primary intended outcome is to strengthen businesses with a targeted owner desired growth plan. This is to be accomplished as an integrated, comprehensive, phased marketing plan. Integration occurs at two points. The first is the integration of technology into a small business marketing plan. The second integrating point is that of entity participation. Marketing plans to-date typically focus on company advertising to entice and target the consumer, with few who utilize marketing from the consumer perspective. Business strength and failings impact owners, consumers and the communities they're a part of. Therefore the this marketing plan incorporates a community component, consumer and business owner to create a comprehensive plan. The phased aspect of the plan is three-fold. The first establishes a business Internet presence. The second phase connects business presence within the community and community-based organizations and other businesses. The third phase initiates a consumer accessible ease of business information of location based content. The first phase is establishment of a small-to-medium-sized business post board style advertising website. The business board website intention is to increase name recognition, provide summary of business good/services offered made available for, and to create an online presence with business information and description presented in a catalogue geographic access style. The post board style website displays business name, a brief description of good/services, location, logo, contact information, website link if applicable, as determined by owners within the business board outline. Information is accessed through location and category clickable tabs. Tabs will be accessible first by state, then city, and finally by category. A navigation option will be available for users.

Phase two creates connection, with relationship development. The intention is strengthening and growing businesses via connecting business owners with their community of location and community organizations in two ways. The first utilizes technology by placing a website link of the business board, post-board website on city, county, state and community organization websites. Establishing accessible links through these organizations provides resident customers connected to these organizations with business information, or at the very least, residents, new residents, and visitors to the area with easy access to business information. This connection also allows these entities to become a part of business growth and strength with the businesses located in their jurisdiction in passive promoting context. Further relationship development is possible from this initial connection, dependent about link hosting entity remaining a passive, or becoming an active promoter. Additionally, phase two includes a physical, outdoor sign board structure option. The style will be the same as the business board website post-board display style, in changeable type for business opt-in and out. Key to the outdoor sign post-board is placement in a prominent, heavily pedestrian trafficked area. Information on both the website and outdoor signboard structure includes how to access the downloadable application to mobile devices for good/service seekers for ongoing use, to be explained in phase three. Both aspects are intentioned to encourage community involvement of strengthening and growing businesses within their jurisdiction.

Phase three is the stage in which the customer/user/good/service seeker is integrated into the comprehensive marketing plan. This aspect of connection and relationship development also further integrates technology to create a non-intrusive business information local based content methodology. Local based content is made available at customer fingertips via downloadable application and QR scanning code to their mobile device. The application is downloadable from the business board website and the QR scanned code from the outdoor signboard structure. This allows users direct access to local content from their mobile device in quick easy steps with a few clicks.

This invention is a comprehensive marketing plan integrating technology and encompassing all participants or impacted entities designed to serve small-to-medium-sized businesses. Utilizing and adapting existing technology and creating a website as a downloadable application for mobile device use finalizes the plan to include the customer/user and/or good/service seeker into the marketing plan in a non-intrusive, user opt-in methodology. This methodology provides a process for small and medium sized businesses to grow and strengthen at an owner desired targeted growth strategy which not only integrates and connects businesses with community, but also simultaneously strengthens their community.

1. Method of business promoting service comprising;
An individual business name business good service business general information business promotional material and discounts and incentives business location and navigation to business
Wherein said individual business name business good service business general information business promotional material and discounts and incentives business location and navigation to business is for presenting and compiling in the following manner;
Said compiling of each individual business name business good service business general information business location and navigation to business for displaying seeing and accessing said displaying is of a sign poster-board-styling of each individual business name business good service business general information business promotional material and discounts and incentives business location and navigation to business in said compiling consisting of together within an internet storage option as one of the following
a) a local server data storing machine
b) a cloud-based data storing service
c) a combination of said local service storing and said cloud-based data storing or with data storing device and or services

2. A displaying of said compiling of each said individual business name business good service business general information business promotional material and discounts and incentives business location and navigation to business as in claim 1, further comprising, in said storing devices and service displaying said individual business name business good service business general information business promotional material and discounts and incentives business location and navigation to business of said poster-board-styling as an internet web page

3. A promoting of said web page displaying on designated web page address of said compiling individual business name business good service business general information business promotional material and discounts and incentives business location and navigation to business as in claim 2, further comprising, will provide web page search options using alphabetical categorizing of said compiling individual business name business good service business general information business promotional material and discounts and incentives business location and navigation to business of said storing data

4. A promoting using said webpage displaying at designated web page address of said compiling individual business name business good service business general information business promotional material and discounts and incentives business location and navigation to business of said individual business name business good service business general information business location and navigation to business, as in claim 3, further comprising, providing web page search options using locating said compiling of said individual business name business good service business general information business promotional material and discounts and incentives business location and navigation to business geographic location of city county and state of said storing data

5. A compiling each said individual business name business good service business general information business promotional material and discounts and incentives business location and navigation to business, on said web page at said web address, of claim 4, further comprising, posting personal stories and or reviews displaying user experiences as part of the promoting marketing utilizing technologies of video audio or sticky notes—of either said individual business name business good service business general information business promotional material and discounts and incentives business location and navigation to business customer reviewing or said website at said web address customer reviewing

6. A promoting of said individual business name business good service business general information business promotional material and discounts and incentives business location and navigation to business, as in claim 5, further comprising featuring said individual business name business good service business general information business promotional material and discounts and incentives business location and navigation to business using text audio video and voice controlling and accessing

7. An expanding promoting said individual business name business good service business general information business promotional material and discounts and incentives business location and navigation to business as in claim 6, further comprising, increasing exposing via pursuing said web page of said displaying of said poster-board-styling of said compiling individual business name business good service business general information business promotional material and discounts and incentives business location and navigation to business said storing displaying web address link on local geographic community organizations and government websites as partnering said promoting of said compiling individual business name business good service business general information business promotional material and discounts and incentives business location and navigation to business said displaying and said storing individual business name business good service business general information busines location and navigation to business data

8. An expanding and exposing said compiling each said individual business name business good service business general information business promotional material and discounts and incentives business location and navigation to business, as in claim 1, further comprising via connecting said individual business name business good service business general information business promotional material and discounts and incentives business location and navigation to business location geographically to different businesses within geographic proximity of 50 miles or less and any other different businesses and locations as willing and or pursued and of jurisdiction city and or county boundaries to said displaying other said individual business name business good service business general information business promotional material and discounts and incentives business location and navigation to business connecting the business community of said individual business name business good service business general information business promotional material and discounts and incentives business location and navigation to business as a business to business relationship developing and promoting tool

9. A linking said compiling said individual business name business good service business general information business promotional material and discounts and incentives business location and navigation to business said displaying and said compiling each said individual business name business good service business general information business promotional material and discounts and incentives business location and navigation to business said storing data via said online web page of said promoting poster-board-styling displaying, as in claim 6 further comprising as a downloading application of mobile device using for users as an ease of accessing said individual business name business good service business general information business promotional material and discounts and incentives business location and navigation to business of the mobile device using user as an alternate non-internet furthering promoting, utilizing said storing data

10. A said promoting and said displaying of said compiling individual business name business good service business general information business promotional material and discounts and incentives business location and navigation to business, as in claim 1, further comprising expanding and exposing said community marketing via erecting an outdoor displaying changeable signage board constructing within predetermined heavily pedestrian trafficked areas as another alternate non-internet furthering promoting, utilizing said storing data

11. A promoting taking together each said seeing and accessing of said compiling each said individual business name business good service business general information business promotional material and discounts and incentives business location and navigation to business in said displaying manner of said compiling individual business name business good service business general information business promotional material and discounts and incentives business location and navigation to business said storing and said application for mobile device using for users, as in claim 8, further comprising increasing exposing and name recognizing and knowing of each said individual business name business good service business general information business promotional material and discounts and incentives business location and navigation to business for increasing decision-making of using to be a customer of said individual business name business good service business general information business promotional material and discounts and incentives business location and navigation to business is a comprehensive holistic marketing strategy
